(19) United States
(12) Patent Application Publication
(10) Pub. No.: US 2024/0273846 A1
(43) Pub. Date: Aug. 15, 2024

(54) METHOD, APPARATUS, AND ELECTRONIC DEVICE FOR INTERACTION

(71) Applicant: Beijing Zitiao Network Technology Co., Ltd., Beijing (CN)

(72) Inventor: Cheng Guo, Beijing (CN)

(21) Appl. No.: 18/436,869

(22) Filed: Feb. 8, 2024

(30) Foreign Application Priority Data
Feb. 9, 2023 (CN) 202310132991.8
Feb. 9, 2023 (CN) 202310143115.5

(51) Int. Cl. G06T 19/20; G06T 19/00

(52) U.S. Cl. CPC G06T 19/20; G06T 19/003

(57) ABSTRACT

Embodiments of the disclosure discloses a method, apparatus, and electronic device for interaction. The method includes: in response to an object operation of a first user for a three-dimensional scene, sending prompt information to a second user, wherein the object operation is used to modify an object in the three-dimensional scene or add an object into the three-dimensional scene, and the prompt information is used to notify an operation content of the object operation and/or the three-dimensional scene. In this way, the interaction between users under the three-dimensional scene application can be implemented, and the interaction experience of users in the three-dimensional scene application can be improved.

### CROSS-REFERENCE

The present application claims priority to Chinese Patent Application No. 202310143115.5 filed on Feb. 9, 2023, and entitled “METHOD, APPARATUS, AND ELECTRONIC DEVICE FOR INTERACTION”; the present application further claims priority to Chinese Patent Application No. 202310132991.8 filed on Feb. 9, 2023, and entitled “METHOD, APPARATUS AND ELECTRONIC DEVICE FOR INFORMATION INTERACTION”, both of the entirety of which are incorporated herein by reference.

### FIELDS

The present disclosure relates to the field of virtual reality, and in particular, to a method, apparatus, and electronic device for interaction, and a method, apparatus, and electronic device for information interaction.

### BACKGROUND

With the maturity of three-dimensional technology, users can experience more and more three-dimensional applications.

In the current three-dimensional scene application, users may create virtual three-dimensional scenes for other users to visit. For example, users may post the created virtual room, and then other users may visit the virtual room.

### SUMMARY

The portion of the present disclosure is provided in order to briefly introduce ideas which will be described in detail later in the section on specific embodiments. This public content section is not intended to identify the key features or necessary features of the claimed technical solution, nor is it intended to limit the scope of the claimed technical solution.

Embodiments of the present disclosure provide a method, apparatus, and electronic device for interaction to implement interaction between a user in a three-dimensional scene application, to improve an interaction experience of the user in a three-dimensional scene application.

In a first aspect, embodiments of the present disclosure provide a method for interaction. The method comprises, in response to an object operation of a first user for a three-dimensional scene, sending prompt information to a second user, wherein the object operation is used to modify an object in the three-dimensional scene or add an object into the three-dimensional scene. The prompt information is used to notify an operation content of the object operation and/or the three-dimensional scene.

In a second aspect, embodiments of the present disclosure provide an apparatus for interaction. The apparatus comprises: a prompt unit configured to, in response to an object operation of a first user for a three-dimensional scene, send prompt information to a second user, wherein the object operation is used to modify an object in the three-dimensional scene or add an object into the three-dimensional scene. The prompt information is used to notify an operation content of the object operation and/or the three-dimensional scene.

In a third aspect, embodiments of the present disclosure provide an electronic device. The electronic device comprises: one or more processors; and a storage device for storing one or more programs, the one or more programs, when executed by the one or more processors, causing the one or more processors to implement the method as described in the first aspect.

In a fourth aspect, embodiments of the present disclosure provide a computer-readable medium having a computer program stored thereon, characterized in that the program, when executed by a processor, implements the method as described in the first aspect.

In the method, apparatus, and electronic device for interaction provided in the present disclosure, the first user may perform an object operation, such as modifying an object in the three-dimensional scene or adding an object into the three-dimensional scene. The second user will then receive prompt information. Interaction between users under the three-dimensional scene application may be implemented in the above manner, and the interaction experience of users in the three-dimensional scene application may be improved.

The present disclosure further provides a method, device, and electronic device, which may enable a plurality of users to jointly complete the construction of a three-dimensional scene, thereby enhancing the experience of all users.

In a first aspect, embodiments of the present disclosure provide a method of information interaction, comprising: in response to an object addition operation of the first user in a three-dimensional scene, obtaining an added object by a first user; the three-dimensional scene being created by a second user; in response to an object placement operation of the first user in the three-dimensional scene, placing the added object at a target position determined by the first user in the three-dimensional scene.

In a second aspect, embodiments of the present disclosure provide an apparatus for information interaction, comprising: an obtaining unit configured to in response to an object addition operation of the first user in a three-dimensional scene, obtaining an added object by a first user; the three-dimensional scene being created by a second user; a placement unit configured to in response to an object placement operation of the first user in the three-dimensional scene, placing the added object at the target position determined by the first user in the three-dimensional scene.

In a third aspect, embodiments of the present disclosure provide an electronic device, comprising: one or more processors; a storage configured to store one or more programs, the one or more programs, when executed by the one or more processors, causing the one or more processors to implement the method as described in the first aspect.

In a fourth aspect, embodiments of the present disclosure provide a computer-readable medium having a computer program stored thereon, the program, when executed by a processor, implementing the steps of the method of information interaction as described in the first aspect.

The method, device, and electronic device of information interaction provided in embodiments of the present disclosure in response to an object addition operation of the first user in a three-dimensional scene, obtaining an added object by a first user, and then in response to an object placement operation of the first user in the three-dimensional scene, placing the added object at a target position determined by the first user in the three-dimensional scene. Due to the three-dimensional scene being created by a second user, thus by this method, which may enable different users to jointly complete the construction, modification, and addition of a three-dimensional scene, that is, which may enable to get rid of the fixed mode of constructing the three-dimensional scene by a single user and enhancing the interactive experience of all users.

### BRIEF DESCRIPTION OF THE DRAWINGS

The foregoing and other features, advantages, and aspects of embodiments of the present disclosure will become more apparent in conjunction with the accompanying drawings and with reference to the following specific embodiments. Throughout the accompanying drawings, the same or similar accompanying markings represent the same or similar elements. It should be understood that the accompanying drawings are schematic and that the originals and elements are not necessarily drawn to scale.

FIG. 1 is a flowchart of one or more embodiments of a method for interaction according to the present disclosure;

FIG. 2 is a schematic diagram of a three-dimensional scene in one or more embodiments of a method for interaction according to the present disclosure;

FIG. 3 is a schematic diagram of a three-dimensional scene in one or more further embodiments of a method for interaction according to the present disclosure;

FIG. 4 is a schematic diagram of prompt information in one or more embodiments of a method for interaction according to the present disclosure;

FIG. 5 is a structural schematic diagram of one or more embodiments of an apparatus for interaction according to the present disclosure;

FIG. 6 is a flowchart of one or more embodiments of a method of information interaction according to the present disclosure;

FIG. 7 is a schematic diagram of a three-dimensional scene according to one or more embodiments of the method of information interaction of the present disclosure;

FIG. 8 is a schematic diagram of a message control according to one or more embodiments of the method of information interaction of the present disclosure;

FIG. 9 is a schematic diagram of a message control according to one or more further embodiments of the method of information interaction of the present disclosure;

FIG. 10 is a schematic diagram of a message control according to yet one or more further embodiments of the method of information interaction of the present disclosure;

FIG. 11 is a schematic diagram of a three-dimensional scene according to one or more further embodiments of the method of information interaction of the present disclosure;

FIG. 12 is a schematic diagram of a message control according to one or more further embodiments of the method of information interaction of the present disclosure;

FIG. 13 is a schematic diagram of a three-dimensional scene according to yet one or more further embodiments of the method of information interaction of the present disclosure;

FIG. 14 is a schematic diagram of a prompt corresponding to a message content according to one or more embodiments of the method of information interaction of the present disclosure;

FIG. 15 is a schematic structural diagram according to one or more embodiments of the method of information interaction device of the present disclosure;

FIG. 16 is an exemplary system architecture in which a method for interaction of one or more embodiments of the present disclosure may be applied; and

FIG. 17 is a schematic diagram of a basic structure of an electronic device provided according to the present disclosure.

### DETAILED DESCRIPTION

Embodiments of the present disclosure will be described in greater detail below with reference to the accompanying drawings. Although certain embodiments of the present disclosure are shown in the accompanying drawings, it should be understood, however, that the present disclosure may be implemented in a variety of forms and should not be interpreted as being limited to the embodiments set forth herein, but rather are provided for a more thorough and complete understanding of the present disclosure. It should be understood that the accompanying drawings and embodiments of the present disclosure are for exemplary purposes only and are not intended to limit the scope of protection of the present disclosure.

It should be understood that the various steps documented in the method embodiments of the present disclosure may be performed in a different order, and/or in parallel. Furthermore, the method embodiments may comprise additional steps and/or omit performing the illustrated steps. The scope of the present disclosure is not limited in this regard.

As used herein, the term “comprising” and its variations are open-ended, i.e., “comprising, but not limited to”. The term “based on” is “based at least in part on”. The term “one embodiment” means “at least one embodiment”; the term “on or more further embodiment” means “at least one further embodiment”; and the term “some embodiments” means “at least some embodiments”. Related definitions of other terms will be given in the following description.

It should be noted that the concepts of “first”, “second” and the like mentioned in the present disclosure are only used to differentiate different apparatuses, modules, or units, and are not intended to limit the order or interdependence of the functions performed by these apparatuses, modules, or units.

It should be noted that the modifications of “one” and “plurality” mentioned in the present disclosure are schematic rather than limiting, and the person skilled in the art should understand that, unless otherwise expressly stated in the context, they should be understood as “one or more”.

The names of the messages or information interacted with between the plurality of apparatuses of the presently disclosed embodiments are used for illustrative purposes only and are not intended to place limitations on the scope of those messages or information.

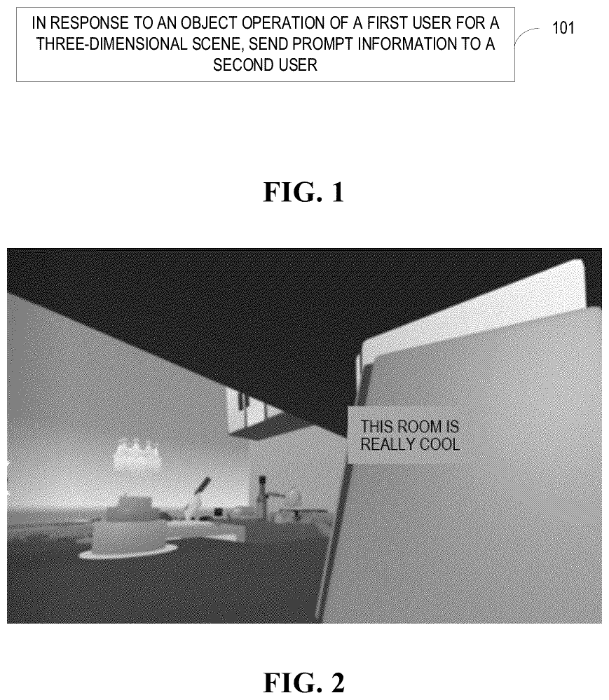

Referring to FIG. 1, which illustrates a flow of one or more embodiments of a method for interaction according to the present disclosure. The interaction method may be applied to a terminal device. The interaction method, as shown in FIG. 1, comprises the following steps.

In step 101, in response to an object operation of a first user for a three-dimensional scene, send prompt information to a second user.

Herein, the three-dimensional scene may be a VR (Virtual Reality) application, such as a VR chat room, a VR livestreaming room, etc., the three-dimensional scene may also be a three-dimensional game scene, and the three-dimensional scene may also be a virtual room constructed by the user according to his or her preferences.

The above-mentioned operation is used to modify an object in the three-dimensional scene or add an object into the three-dimensional scene, and the prompt information is used to notify an operation content of the object operation and/or the three-dimensional scene. For example, after the first user performs the object operation in the three-dimensional scene, the second user may receive the operation content of the object operation performed by the first user, such as the second user receiving that the first user has added an object A into the three-dimensional scene. Another example is that after the first user performs the object operation in the three-dimensional scene A, the second user may receive an indication that the three-dimensional scene A has been altered.

Herein, modifying the objects in the three-dimensional scene may comprise modifying the parameters of the existing objects in the three-dimensional scene, or deleting the existing objects in the three-dimensional scene. When the first user adds an object into the three-dimensional scene, the second user may be a creator, a co-creator, or a follower, etc., of the three-dimensional scene. When the first user modifies the object in the three-dimensional scene, the second user may be the user who added the object, or may be the creator, co-creator, or follower, etc., of the three-dimensional scene.

That is, the second user described above may be any other user in the three-dimensional scene. The second user described above may also be a user associated with an object corresponding to the object operation of the first user, or the second user may also be a user associated with the three-dimensional scene.

By way of example, when the corresponding object of the object operation is a building A in the three-dimensional scene, the second user may be a user who creates the building A, the second user may also be any other user who is in the three-dimensional scene at the time, and the second user may also be a user who co-creates the three-dimensional scene or a user who adds attention to the three-dimensional scene. Whereas, when the object operation is to add building B to the three-dimensional scene, the second user may be the creator, the co-creator, or the concerned person of the three-dimensional scene. Certainly, the second user may also be any other user who is in the three-dimensional scene at that time.

Optionally, the object corresponding to the object operation may be a message information. Then the object operation may comprise adding the message information to the three-dimensional scene. Accordingly, the second user may be a creator of the three-dimensional scene.

By way of example, referring to FIG. 2, in a VR application scene, a user can construct a corresponding virtual environment according to his/her own preferences, i.e., the user can construct a personalized room (i.e., a three-dimensional scene) by way of editing a virtual object, and then, the user can act as a creator to post the room he/she has built for browsing and visiting by other users. Other users can leave a message about the room during their visit, i.e., add a message here. For example, the first user A, when visiting room B, thinks that room B is cool, then the first user A can add a message in the room B, such as a message in the form of text “This room is really cool”. Then, the creator of the room B will receive a prompt information.

That is, one or more embodiments of the present application provides a manner for interaction by adding a message.

The form of the message information described above may also comprise, but is not limited to, pictures, videos, emoticons, voice, and recorded information. The recorded information may be an image video in the VR. The emoticon may be a dynamic emoticon, a static emoticon, or a meme.

By way of example, when the first user sees a beautiful scene in the three-dimensional scene, the first user may add a picture or video associated with the beautiful scene in the three-dimensional scene, and the first user may also take a group photo with the beautiful scene or leave a recorded video with the beautiful scene in the beautiful scene.

When the object corresponding to the object operation is message information, the object operation may also comprise replying to the message information in the three-dimensional scene; wherein the reply to the message information is equivalent to a modification of the existing object. Accordingly, the second user may be a user who adds the message information.

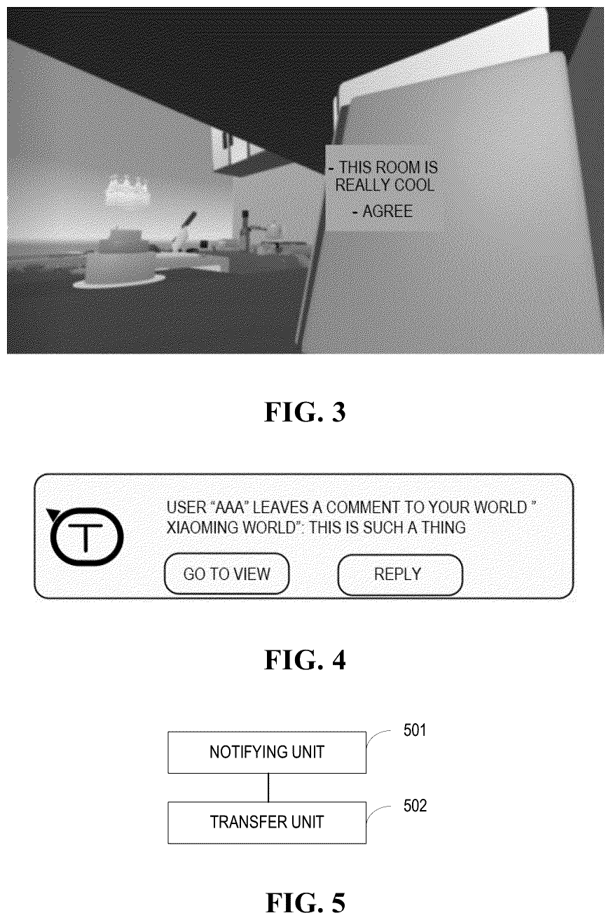

By way of example, referring to FIG. 3, in a VR application scene, a user can construct a corresponding virtual environment according to his/her own preferences, i.e., the user can construct a personalized room (i.e., a three-dimensional scene) by editing a virtual object, and then the user acts as a creator to post the room that he/she has built for browsing and visiting by other users. Other users can leave comments on the room during the browsing process. Or reply to the existing message information. For example, the second user C, when visiting room B, thinks that room B is cool, then the second user C can add a message in the room B, such as the text form of the message information “this room is really cool”. The first user A, while visiting the room B, sees the message information added by the second user C, and can reply to the message information, for example, if the first user A endorses the message of the second user C, then the first user A can reply “Agree”.

In other embodiments, the object in the three-dimensional scene may also be a virtual object such as a message board, a message column, a graffiti wall, and the like constructed by the creator for interacting with the other users, which in turn enables the other users to perform object operations based on the virtual object.

The above-described prompt information may comprise the operation content of the object operation performed by the first user, such as the specific content of the message information added by the first user. The prompt information may also comprise a three-dimensional scene in which the first user is located, information about the first user, or the location of the object corresponding to the object operation performed by the first user, etc., without limitation of the present application.

Optionally, the object operation may also be texturing, adding scene buildings, voting, and so on.

It is to be understood that the object may be a three-dimensional virtual object including at least one geometry, which exists in the three-dimensional scene in a certain position, attitude, and volume; the object may also be a picture or text, etc., which exists in a certain plane in the three-dimensional scene; and the object may be other multimedia data embodied as a predetermined virtual control. The message information may be a three-dimensional virtual object consisting of a plurality of geometries in the shape of text, a picture including the text or the text itself, or other multimedia data displayed as a control that will play the multimedia data when the control is triggered.

By way of example, in a three-dimensional application scene, a plurality of users can work together to complete the construction of a virtual house, i.e., the plurality of users all perform an object operation in the virtual house, where the object operation can be specified as adding a virtual component into the virtual house, where the virtual component is an object that is added, and the virtual component can be a bed, a table, a chair, and so on. After one of the users performs the object operation in the virtual house, prompt information is sent to the other co-creators.

By way of example, in a three-dimensional application, a user may vote on an existing plurality of three-dimensional scenes (the three-dimensional scenes may be three-dimensional models constructed by different users), and the voting may be performed by adding a gift at a fixed location of the three-dimensional scene, which is the added object, and when the user adds a gift to the three-dimensional scene A, the creator of the three-dimensional scene A receives the prompt information. Certainly, the creators of other 3D scenes can also receive the prompt information to be informed of the voting status of all the 3D scenes.

In related technology, a user may create a three-dimensional virtual scene for other users to visit. For example, the user may post a virtual room that has been created, and then other users may visit the virtual room. However, the current approach cannot provide a method of interaction between users regarding the virtual three-dimensional scene.

In contrast, with the method of interaction provided by embodiments of the present disclosure, the first user may perform an object operation, such as modifying an object in the three-dimensional scene or adding an object into the three-dimensional scene, after which the second user receives prompt information. The above method can implement the interaction between users under the three-dimensional scene application and improve the interaction experience of users in the three-dimensional scene application.

Optionally, the method may further comprise: in response to a predetermined operation of the second user for the prompt information, transferring the second user to the three-dimensional scene and displaying the three-dimensional scene.

Specifically, after the second user receives the prompt information, the second user may perform a predetermined operation for the prompt information, and thus be transferred to the three-dimensional scene corresponding to the prompt information. It can be understood that the transferring of the second user to the three-dimensional scene may be for displaying the three-dimensional scene for the second user, which may be accompanied by closing or exiting the original display content for the second user.

The above predetermined operation can be that the user clicks “go to view”, or clicks “Transfer”, etc. Specifically, reference can be made to the prompt information shown in FIG. 4, where the creator (corresponding to the second user in this case) creates a three-dimensional scene named “Xiaoming World”. After the first user “AAA” leaves a message in the three-dimensional scene, the creator can click “Go to view”, then the creator can directly enter the three-dimensional scene where the first user “AAA” locates. If the first user “AAA” is currently in the three-dimensional scene, the transferred creator can directly have a face-to-face dialog with the first user “AAA”.

Herein, the message content of the first user also comprises pictures, voice, etc. The creator can also click on the “Reply” operation to communicate with the first user directly and remotely.

As can be seen, in the one or more embodiments of the present application, the first user may perform an object operation, such as modifying an object in the three-dimensional scene or adding an object into the three-dimensional scene. Then, the second user associated with the object operation of the first user will receive prompt information, and the second user may perform a predetermined operation for the prompt information, which may in turn be transferred to the three-dimensional scene. By means of the above-described method of transferring the user to the three-dimensional scene, a social scene between users can be enriched, and is not limited to the transferring of information of users in the same scene, which in turn can improve the interaction experience of the user.

Optionally, the three-dimensional scene corresponds to at least two copies. The copies can also be understood as multiple copies of the same three-dimensional scene, with each reproduction being a copy. Due to performance considerations, usually, if there are too many users experiencing the scene at the same time, the users will be assigned to different “scene copies”. For example, when 100 users enter the same VR (Virtual Reality) application, these 100 users will be automatically assigned to 5 copies of the application, with 20 users in each copy.

In one embodiment, after the first user performs the object operation in the currently located copy, the same operation as the object operation is performed in all other copies corresponding to the three-dimensional scene.

It should be noted that since all the copies are to present the same scene content, after the first user performs an object operation (equivalent to modifying the scene content) in his or her copy, the other copies corresponding to the three-dimensional scene perform the same operation as the object operation and thus present the same operation content.

For example, when the first user adds message information in the copy in which the first user is located, the message information is synchronously presented in the other copies corresponding to the three-dimensional scene.

Accordingly, the above-described step 101 may specifically comprise: in response to an object operation of the first user in a first copy, sending the prompt information to the second user, wherein the first copy is one of the at least two copies of the three-dimensional scene; the first copy being the copy where the first user is located.

That is, the first user is assigned to a first copy corresponding to the three-dimensional scene, and the first user may perform an object operation in the first copy. The electronic device in turn in response to the object operation of the first user, sends prompt information to the second user.

In this embodiment, the above-described step of transferring the second user to the three-dimensional scene may specifically comprise: transferring the second user to the first copy or other copies corresponding to the three-dimensional scene.

It is to be noted that since all the copies will present the same scene content. Thus, in this embodiment, the second user may be transferred to any copy corresponding to the three-dimensional scene, and the second user will be able to see the operation content corresponding to the object operation of the first user in any of the copies.

It is to be understood that all the copies corresponding to the three-dimensional scene may also be comprised in the above prompt information, which in turn enables the second user to also select the copy to which the second user is to be transferred when performing the predetermined operation.

In this embodiment, the above-described steps in response to a second user for a predetermined operation of the prompt information, transferring the second user to the three-dimensional scene, may further comprise: in response to a predetermined operation of the second user for the prompt information, and in response to determining that the first user is located in the first copy, transferring the second user to the first copy.

That is, after the second user performs a predetermined operation for the prompt information, at this time, the electronic device may determine whether the first user is currently still located in the first copy. If the first user is currently still located in the first copy, the second user may be transferred to the first copy, and in this way, the second user may be able to interact face-to-face with the first user in the same copy. That is, when the first user performs an object operation in the first copy, the user associated with the object operation may be transferred to the first copy in which the first user is located immediately after receiving the prompt and interact face-to-face with the first user. In this way, the interaction experience between the users can be improved, and the interaction is not limited to the users in the current copy.

If the electronic device determines that the first user is not currently located in the first copy, the second user may be transferred to any of the copies corresponding to the three-dimensional scene.

In an embodiment, the prompt information is displayed in a second copy where the second user is located when the second user is in the second copy corresponding to the three-dimensional scene; the second copy is one of at least two copies corresponding to the three-dimensional scene, and the second copy is different from the first copy.

Accordingly, the above step of transferring the second user to the first copy, which may specifically comprise: transferring the second user from the second copy to the first copy.

By way of example, if the first user A performs an object operation in the first copy, and the second user B in the second copy receives the prompt information, the second user B may perform the predetermined operation, and may in turn be transferred to the first copy for face-to-face interaction with the first user A.

It can be understood that although the second user B is also able to see the operation content of the first user A performing the object operation in the second copy, the second user B is not able to directly interact face-to-face with the first user A because the first user A and the second user B are located in different copies. Therefore, the above-described method can cause the second user B to be transferred to the copy in which the first user A is located, thereby implementing face-to-face interaction between users between different copies.

In yet one or more further embodiment, when the second user is in another scene, then the prompt information is displayed in the other scene where the second user is.

Accordingly, the above step of transferring the second user to the first copy, which may specifically comprise: transferring the second user from other scenes to the first copy.

It is to be noted that the other scene and the three-dimensional scene need to be the same user account to enable the second user to receive the prompt information from the three-dimensional scene sent by the first user after logging into the account.

That is, in the above manner, a user located in the other scene can be enabled to also be transferred to the first copy in which the first user is located and interact face-to-face with it after receiving the prompt information.

Optionally, the above step of transferring the second user to the three-dimensional scene and may also specifically comprise: transferring the second user to a target location in the three-dimensional scene.

Herein, the target position comprises any of the following: an initial position of a user in the three-dimensional scene, a position corresponding to the object operation, and a position corresponding to the first user.

It can be understood that the location corresponding to the object operation can be an arbitrary location around the object of the object operation, or it can be a location spaced a first predetermined distance apart in a first direction of the object corresponding to the object operation.

Accordingly, the location corresponding to the first user may be at an arbitrary position around the first user or may be at a position spaced a second predetermined distance in a second direction of the first user.

It should be noted that the initial position of the user in the three-dimensional scene is determined by the creator. While in a three-dimensional application scene, the initial position of the user is the birth position of the user in the three-dimensional application scene.

The first direction, the second direction, the first predetermined distance, and the second predetermined distance described above may be set according to the actual situation. For example, the target position for transferring the second user to the three-dimensional scene may be a position five meters apart on the left side of the object corresponding to the object operation. For another example, the target position for transferring the second user to the three-dimensional scene may be at a position two meters apart on the right side of the first user.

Optionally, the above-described transferring the second user to a target location in the three-dimensional scene may further comprise: transferring the second user to the target location in the three-dimensional scene and turning the second user towards an object corresponding to the object operation. That is, the display perspective corresponding to the second user is adjusted based on the position of the object corresponding to the object operation in the three-dimensional scene, enabling the object corresponding to the object operation to appear in whole or in part in the display content of the second user.

Specifically, when transferring the second user to the target location in the three-dimensional scene, the second user can be caused to turn toward the object corresponding to the object operation, which in turn enables the second user to first view the operation content corresponding to the object operation performed by the first user. For example, when a user adds message information in the three-dimensional scene, and the second user is able to view the message information at the first time after being transferred to the target location in the three-dimensional scene in the above-described manner.

Optionally, the above-described transferring the second user to the target position in the three-dimensional scene may further comprise: transferring the second user to the target location in the three-dimensional scene, and in response to determining that the first user is located in the three-dimensional scene, turning the second user towards the first user. That is, the corresponding display perspective of the second user is adjusted based on the position of the first user in the three-dimensional scene, so that the virtual character corresponding to the first user in the three-dimensional scene can appear in whole or in part in the display content of the second user.

Specifically, in the process of transferring the second user to the target location in the three-dimensional scene, the first user can be determined whether the first user is still in the three-dimensional scene, and if the first user is still in the three-dimensional scene, the second user can be turned toward the first user, which allows the second user to directly interact face-to-face with the first user without having to adjust its position.

If the first user is not in the three-dimensional scene, the second user can be turned toward any position, and the present application is not limited.

In one embodiment, the second user may also reply to the prompt information, i.e., the method may further comprise: in response to a reply operation of the second user for the prompt information, adding a reply content to the three-dimensional scene, or in response to the reply operation of the second user for the prompt information, sending the reply content to the first user.

By way of example, after the first user adds message information in the three-dimensional scene, the second user can reply to the message information, and the reply content can be directly added to the three-dimensional scene or sent to the first user.

By way of example, when the first user adds a gift to the three-dimensional scene for voting, the second user can reply, for example, by sending the reply content “Thank you for your support” to the first user.

Referring further to FIG. 5, as an implementation of the method shown in each of the above figures, the present disclosure provides one or more embodiments of an apparatus for interaction. The apparatus embodiment corresponds to the one or more embodiments of the method for interaction shown in FIG. 1, and which can be specifically applied in various electronic devices.

As shown in FIG. 5, the apparatus for interaction of the present embodiment comprises: a notifying unit 501 configured to, in response to an object operation of a first user for a three-dimensional scene, send prompt information to a second user, wherein the object operation is used to modify an object in the three-dimensional scene or add an object into the three-dimensional scene, and the prompt information is used to notify an operation content of the object operation and/or the three-dimensional scene.

In some embodiments, the apparatus further comprises: a transfer unit 502 configured to, in response to a predetermined operation of the second user for the prompt information, transfer the second user to the three-dimensional scene and displaying the three-dimensional scene.

In some embodiments, the three-dimensional scene corresponds to at least two copies, after the first user performs the object operation in a current copy, performing a same operation as the object operation in other copies corresponding to the three-dimensional scene.

In some embodiments, the three-dimensional scene corresponds to at least two copies. The notifying unit 501, further configured to, in response to an object operation of the first user in a first copy, send the prompt information to the second user, wherein the first copy is one of the at least two copies of the three-dimensional scene. Accordingly, the transfer unit 502, further configured to, in response to a predetermined operation of the second user for the prompt information, and in response to determining that the first user is located in the first copy, transfer the second user to the first copy.

In some embodiments, the prompt information is displayed in a second copy where the second user is located, and the second copy is one of at least two copies of the three-dimensional scene, the second copy being different from the first copy; the transfer unit 502, further configured to transfer the second user from the second copy to the first copy.

In some embodiments, the prompt information is displayed in another scene where the second user is located; the transfer unit 502, further configured to transfer the second user from the other scene to the first copy.

In some embodiments, the transfer unit 502 is further configured to transfer the second user to a target location in the three-dimensional scene; wherein the target location comprises any of: an initial position of a user in the three-dimensional scene, a position corresponding to the object operation, and a position corresponding to the first user.

In some embodiments, the transfer unit 502, further specifically transfers the second user to the target location in the three-dimensional scene and turns the second user towards an object corresponding to the object operation; or transfers the second user to the target location in the three-dimensional scene, and in response to determining that the first user is located in the three-dimensional scene, turns the second user towards the first user.

In some embodiments, the apparatus further comprises: a reply unit. The reply unit is configured to, in response to a reply operation of the second user for the prompt information, add a reply content to the three-dimensional scene, or in response to the reply operation of the second user for the prompt information, send the reply content to the first user.

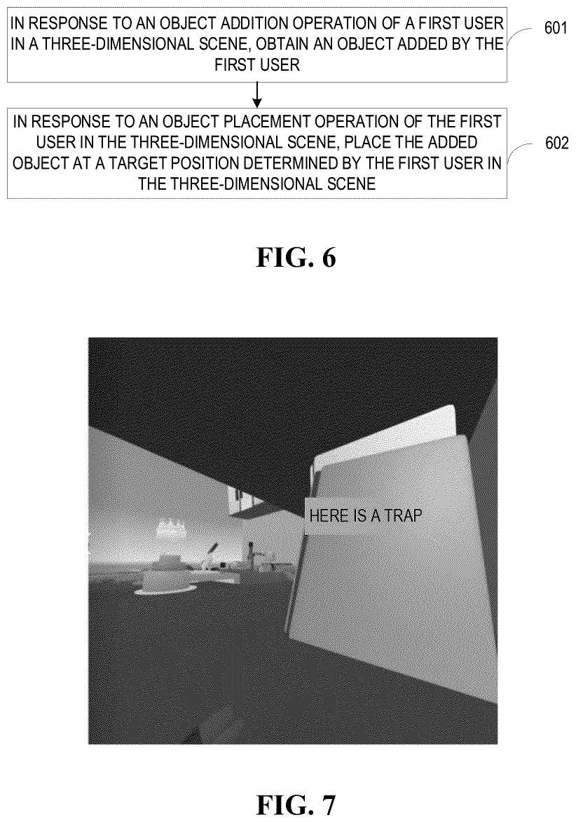

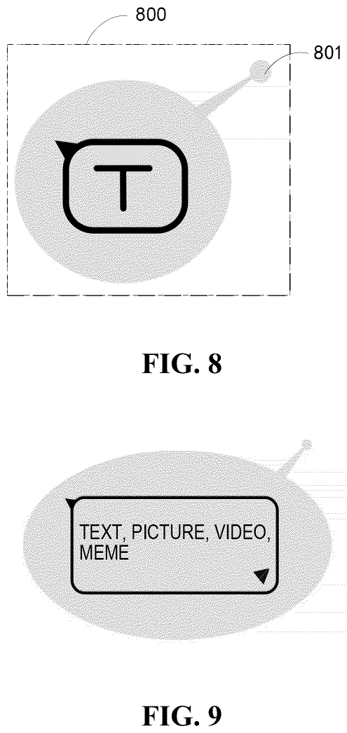

With reference to FIG. 6, which illustrates a flow of one or more embodiments of the method of information interaction according to the present disclosure. The method of information interaction may be applied to an electronic device. As shown in FIG. 6, the method of information interaction includes the following steps:

Step 601, in response to an object addition operation of the first user in a three-dimensional scene, obtaining an added object by a first user.

Among them, the three-dimensional scene is created by the second user.

The three-dimensional scene may be a VR application, such as a VR chat room, a VR LIVE room, or a three-dimensional game scene, and the three-dimensional scene may also be a virtual room created by the user, i.e., User Generated Content (UGC). For example, the second user will publish the virtual room after created it. The first user and the second user are different users.

It is to be illustrated that the above added object may be a three-dimensional virtual object comprising at least one geometric; the object may also be a picture or a text, etc., which may be present in a plane in the three-dimensional scene; and the object may also be other multimedia data embodied as a predetermined virtual control.

In one embodiment, the added object may be a message. The form of the message may be in the form of text, for example, the message added by the first user may be in the form of text “It's so beautiful here”.

Of course, in other embodiments, the form of the message may also comprise but is not limited to a picture, a video, an emoji, a voice, and recorded message. The above recorded message may be a video recording in VR. The emojis may be dynamic emojis, static emojis, or emoticons.

In one embodiment, the added object may be indoor virtual items; for example, if the three-dimensional scene is a virtual room constructed by the second user, the first user may select an indoor virtual item added for the indoor layout of the virtual room. Specifically, the indoor virtual item may be a virtual table, a chair, cabinet, a flowerpot, and the like.

Step 602, in response to an object placement operation of the first user in the three-dimensional scene, placing the added object at a target position determined by the first user in the three-dimensional scene.

That is, after performing the object addition operation, the first user may then perform the object placement operation, thereby may place the added object at the target position selected by the first user in the three-dimensional scene. It should be understood that the first user may directly perform the object addition operation at a certain determined position while performing the object addition operation, and then may not change the position of the added object. At this time, the determined position may be regarded as the target position determined by the user, and the object placement operation may be regarded as performed while performing the object addition operation.

For example, when the added object is a message, the user may add the message to any position in the three-dimensional scene.

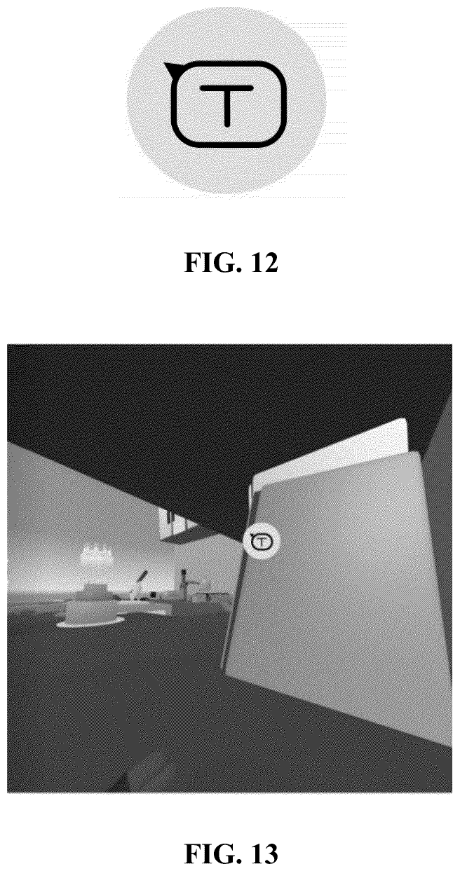

As an example, with reference to FIG. 12, which shows a current display screen of a three-dimensional scene (a type of game scene). During the experience, the first user may leave a message in the three-dimensional scene. For example, after the first user finds that there is a trap at the current position, the first user may leave a message. That is, the first user may perform an object addition operation, such as inputting a message in the form of the text, “There is a trap here”. Then, the first user may perform an object placement operation (such as dragging and dropping the message) to place the message “There is a trap here” on the wall. The wall here is the target position determined by the first user. Of course, the first user may also place the message “There is a trap here” on the floor or float in the air. In this regard, the present application is not limited.

For example, when the first user sees a beautiful scenery in a three-dimensional scene, the first user may add a picture, or a video associated with the beautiful scenery at the target position in the three-dimensional scene. The first user may also take a photo with the beautiful scenery or leave a recorded video with the beautiful scenery.

For example, when the first user sees some exciting content in a three-dimensional scene, the first user may add an emoji representing “joy” or “pleasure” at the target position in the three-dimensional scene. The first user may also add a voice at the target position in the three-dimensional scene. The content of the voice may be “It's so exciting here”, “It's so cool”, and so on.

It should be noted that in some three-dimensional scenes, the form of the message may comprise at least two of the above forms, so that the first user may choose their favorite message method when performing object addition operations.

It may be seen that in the embodiments of the present application, by setting different forms of the message, the message selection of the user may be enriched, thereby increasing the interactivity of the user in the three-dimensional scene as well as increasing the user experience.

Of course, in some three-dimensional scenes, the form of the message may also be a determined form, for example, the form of the message is an emoji. In this regard, the present application is not limited.

For example, when the added object is an indoor virtual item, then the user may add the indoor virtual item to any position in the three-dimensional scene.

For example, the first user may select the indoor virtual item added for the indoor layout of the virtual room. For example, when the table in the virtual room is too monotonous, the first user may add a plurality of flowerpots to the table in the virtual room. That is, the first user may place the plurality of flowerpots at a plurality of target positions on the table by performing object placement operations.

In related technology, the user may create a virtual three-dimensional scene for other users to visit. Specifically, the user may publish the created virtual room, and then other users may visit the virtual room. However, this method may allow only one creator to design and to create the three-dimensional scene, and other visiting users cannot participate together. For example, in a virtual room, other users cannot express modification opinions to the design, or for example, after the user publishes a three-dimensional game, other users cannot add interactive information to the three-dimensional game scene with respect to the game.

In the one or more embodiments of the present application, in response to an object addition operation of the first user in a three-dimensional scene, obtaining an added object by a first user, and then, in response to an object placement operation of the first user in the three-dimensional scene, placing the added object at a target position determined by the first user in the three-dimensional scene. Due to the three-dimensional scene itself being created by a second user, thus by this way, which may enable different users to jointly complete the construction, modification, and addition of a three-dimensional scene. That is, which may enable to get rid of the fixed mode of constructing the three-dimensional scene by a single user and enhancing the interactive experience of all users.

Alternatively, the above three-dimensional scene corresponds to at least two copies. The presentation contents in the plurality of copies corresponding to the three-dimensional scene are the same. The copies may also be understood as a plurality of copies of the same three-dimensional scene, with each copy of the content being a copy.

For example, if 100 users log in to the same VR application, the 100 users may be automatically assigned to 5 application copies, with 20 users assigned to each application copy.

For example, if 50 users watch the VR LIVE broadcast of the same concert at the same time, the 50 users may be automatically assigned to two LIVE room copies, with 25 users assigned to each LIVE room copy.

The number of copies above may be pre-set or may be set according to the number of online users at the same time. The scope of the present disclosure is not limited in this regard.

Among them, the first user may be any user assigned to the first copy of the three-dimensional scene. The above step 601 may specifically comprise: in response to the object addition operation of the first user in a first copy, obtaining the added object by the first user. Correspondingly, the above step 602 may specifically comprise: in response to the object placement operation of the first user in the first copy, placing the added object at the target position determined by the first user in the first copy.

Among them, after the object is placed at the target position in the first copy, the added object is created at the same position in all other copies corresponding to the three-dimensional scene.

It should be illustrated that due to all the copies are to present the same scene content, after the first user performs an object addition operation, that is, the object placement operation (equivalent to modifying the scene content) in the first copy, all the other copies corresponding to the three-dimensional scene perform the same operation as the object operation, thereby may create the added object at the same position. It should be understood that the same operation may be performed in other already existing copies corresponding to the three-dimensional scene, or the same operation may be performed when a new copy corresponding to the three-dimensional scene is created, so that the operation with the same object operation has been performed in the newly created copy.

For example, if the added object is a message, then after the message is placed at the target position, the message is presented in the same position in other copies corresponding to the three-dimensional scene.

Continuing with the example in FIG. 12, after the first user places the message “There is a trap here” on the wall in the first copy of the three-dimensional scene, the message “There is a trap here” is presented on the same wall in other copies of the three-dimensional scene.

In related technology, if there are too many users experiencing the three-dimensional scene application at the same time, they will be assigned to different “scene copies”. For example, if 100 users log in to the same VR (Virtual Reality) application, the 100 users will be automatically assigned to 5 application copies, with 20 users assigned to each application copy. However, by this way, users in each application copy may only interact with users in the same application copy, and users in different application copies may not interact with each other. For example, users in the same application copy may interact with each other through chat boxes, but chat boxes may not connect users in different application copies. That is, the interaction of information will be limited to the current copy.

However, embodiments of the present disclosure provide a method of information interaction in the above manner, so that may enable the users of different copies to interact with information by way of leaving messages, and at the same time, due to the placement of the message is set by a user-defined, but also increases the manipulation experience of the user.

Alternatively, the above step 601 in response to the object addition operation of the first user in the message of the first copy, obtaining the message content of the first user, may specifically comprise: in response to the object addition operation of a first user in a three-dimensional scene, obtaining the added object by the first user and added content for the added object.

In this case, the added object may be a control or an identifier, etc. For example, when the added content is a message content, the added object may be a message control. Of course, the added object may also be a virtual item as exemplified in the foregoing embodiment, or a text, an emoji, a picture, video, a recorded screen, a voice, etc., which are not limited here. It should be understood that the added object and the added content for the added object may be different, and the amount of information or data contained in the added object may be smaller than the corresponding added content, that is, the added object may be a simpler representation of the added content.

Taking an added object as an example of a message control, when the first user wants to leave a message in a three-dimensional scene, the user may click on the message control in the virtual container, and then may input the message content through the message control.

Among them, the virtual container may be used to store various controls, for example, in some three-dimensional application scenarios, the virtual container may be the user's “backpack” or “schoolbag”; and for example, in some VR applications, the virtual container may be “watch UI (User Interface)” or “UI menu”.

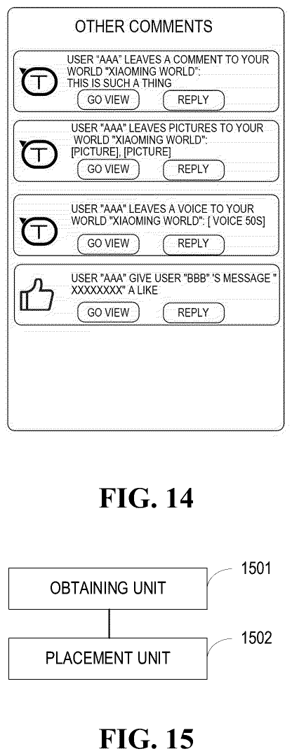

Among them, the message control may be a prop for leaving message, and the first user may leave message through the message control. For example, with reference to FIG. 13, which illustrates a form of message control. The message control 1300 may have an overall semi-translucent sphere shape and the sphere may contain a comment area (the region labeled with letter T in FIG. 13). The comment region is the text box, and the first user may click on the comment region to leave message. The specific form of the message content may refer to the above embodiment, for example, the form of the message content may be a text, a picture, a video, an emoji, etc. as shown in FIG. 14.

With continued reference to FIG. 13, the message control 1300 may include a paste prop 1301 (in the shape of a “tail”).

Correspondingly, the above step 602 places the message content at the target position determined by the first user in the three-dimensional scene, which may specifically comprise: may bond the paste prop 1301 of the message control 1300 to the target position determined by the first user in the three-dimensional scene; wherein the message control 1300 may comprises input content.

That is, the first user may bond the message control 1300 to any position in the scene by the paste prop 1301 of the message control 1300. For example, on the wall, a table, a tree, etc. By the paste prop 1301, it may enable the placement position of the message control 1300 to be more accurate.

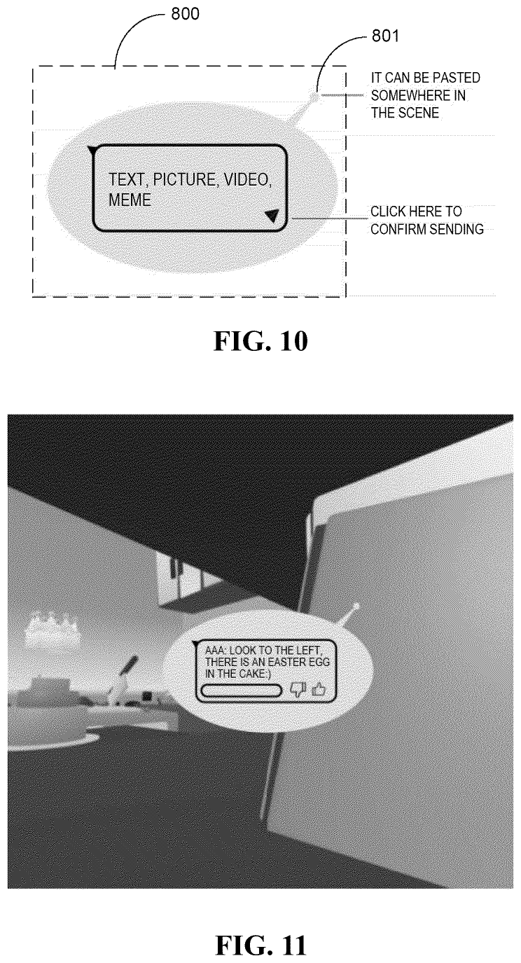

Specifically, with reference to FIG. 10, after the first user inputs the message content, the first user may bond the message control 1300 to any position in the scene by the paste prop 1301, and then the message control 1300 may be sent out by clicking on the lower right corner of the text box. Finally, the presentation effect of the message control may be referred to as shown in FIG. 11, where the message control comprises the message content of the first user AAA, which may be a text information, specifically “Look to the left, there is an Easter egg in the cake”.

In other embodiments, the message control may not comprise a paste prop (FIG. 12), after the first user leaves a message through the message control, the message control may be directly dragged to the target position, the target position needs to enable to carry the message control, for example a target position may be a position on the floor, it may be a position on the table, or a three-dimensional scene of a virtual object may stay or attached position, the present application is not limited thereto.

It should be illustrated that the form of the above message control is only an example and is not limited. For example, the message control may also be a rectangular parallelepiped, and the shape of the paste prop may also be circular or irregular.

In one embodiment, the method may further comprise: after the added object placed in the target position is triggered, the content added may display in the three-dimensional scene.

Continuing with the illustrate of an added object as a message control, when the message control is placed in the target position determined by the first user in the three-dimensional scene, the message content (i.e., content added) may be hidden in the message control, and after the message control is triggered, the message content will be displayed in the three-dimensional scene.

For example, as shown in FIGS. 10 and 13, after the first user inputs the message content through the message control, may stick it on the wall of the scene, and then may click OK to send. The message control that comprises the message content will be changed back to a message control with the letter T (as shown in FIG. 13).

It should be illustrated that when the user adds too much information, the 3D scene may be densely packed with content added of the user (e.g., message content), which may affect the experience of other users who do not care much about the content added. Therefore, the added content may be hidden here, and only a message control that does not show the added content may be displayed. The added content will be displayed in the three-dimensional scene after the added object is triggered. It may be seen that by this method, the experience of the user and user participation may be further improved, and the fun of the three-dimensional scene may also be improved.

As a case of being triggered by an added object, whether an added object is triggered may be determined by the positional relation between the third user and the added object. That is, the method may specifically comprise: in response to the position of the third user and the target position satisfying a predetermined positional relation, may trigger the added object to display the added content in the three-dimensional scene. Among them, the third user may be another user in the three-dimensional scene.

In one embodiment, the above predetermined positional relation may be the distance between the position of the third user and the target position is less than the predetermined distance. That is, the distance between the third user and the added object may determine whether the added object is triggered. Specifically, the above method may further comprise: obtaining the distance between the third user and the target position; in response to the distance between the third user and the target position being less than a predetermined distance, the triggered added object will be hidden in the added content displayed in the three-dimensional scene.

Continuing with the example of the added object is the message control and the added content is the message content. When the third user walks in a three-dimensional scene, the electronic device may detect the distance from the third user to each message control (i.e. target position) in the three-dimensional scene in real time. After it is checked that the distance between the third user and a message control being less than a predetermined distance, the message control being triggered will display the message content hidden therein. This process may refer to the change process of the message control shown in FIGS. 13 to 11. For example, when the third user closes to the wall shown in FIG. 13, after the electronic device detects that the distance between the third user and the message control on the wall is less than a predetermined distance, then the message control being triggered will display the message content hidden therein, and the effect of the display is the effect shown in FIG. 11.

The above predetermined distance may be set differently depending on the three-dimensional scene, for example the predetermined distance may be 1 meter, 5 meters and the like.

As can be seen, the one or more embodiments of the present application may trigger the display of the added content in the added object by the distance between the third user and the target position. By this way, firstly, it is possible to avoid the case that the three-dimensional scene being filled with densely added content from other users, and only the added content within a certain distance from the user may be displayed in the three-dimensional scene. Secondly, by triggering the display of the added content at different positions during the walking process of the user, which may improve the experience of the user and may enhance the fun.

In other embodiments, the above predetermined positional relation may also be a first direction of the third user at the target position. It should be noted that the first direction may be a range of directions; for example, a range of sixty degrees in the east of the target position, or a specific direction, such as due west. After determining the first direction of the third user at the target position, and then triggering the display of the added content, the display effect of the added content may be further improved. That is, it may enable the user in the first direction of the target position to see the added content completely.

In other embodiments, the above predetermined positional relation may also be determined no other virtual object is occluded between the third user and the target position. By this way, the occluded object may be solved on the display effect of the added content, to further improve the experience of the user.

As yet one or more further cases of the added object be triggered, the third user may determine whether to view the added content hidden in the added object by way of triggering an operation. Wherein the third user is another user in the three-dimensional scene.

That is, the method may specifically comprise: in response to the triggering operation of the third user for the added object, it may trigger the added object to display the added content in a three-dimensional scene.

In one embodiment, the above triggering operation may be a direct triggering operation, such as a click operation, a capture operation. Continuing with the example of the added object is the message control and the added content is the message content. When the third user walks in a three-dimensional scene, after encountering a message control, the third user may determine whether they want to view the message content hidden in the message control, for example, when the third user passes through the message control A, if they want to view the message content hidden in the message control A, they may click the message control A, and then the message control A will display the message content hidden therein. When the third user passes through the message control B, if they do not want to view the message content hidden in the message control B at this time, the third user may directly skip the message control B, and the message control B will not display the message content hidden therein.

As can be seen, the one or more embodiments of the present application is triggered by a direct triggering operation of the third user to trigger the display object of the added content in the added object. By this way, the display of the added content may be entirely determined by the third user.

In one embodiment, the above triggering operation may also be an indirect triggering operation, such as the third user operation controller pointing to the added object and be triggered or pointing to an added object and hovering over the added object. The above controller may be a handle, a mouse pointer, a control prop worn by the user, and the like.

In one embodiment, the above indirect triggering operation may also be a third user eye tracking, when the third user gaze on the added object, triggering the display of the added content.

In one embodiment, the method may further comprise: sending the added message to the second user.

Among them, the second user is the creator of the three-dimensional scene in the above embodiment. The added message may comprise an added object, and/or the added content for the added object.

For example, after the first user makes the added object in a three-dimensional scene, the creators of the three-dimensional scene may receive a message reminder. Among them, the creators of the three-dimensional scene may be located in any copy of the three-dimensional scene that they created, or in other three-dimensional scenes, or may not have a related application turned on, etc. It should be noted that other scenes and the three-dimensional scene need to be the same account to enable the creator to receive the message reminder from the three-dimensional scene sent by the first user after logging into the account.

The creator of the three-dimensional scene may choose to reply after receiving the message reminder, such as a text, an emoji, a picture, a video, a recorded screen, a voice, and so on. Of course, the creator of the three-dimensional scene may also choose to add friends or private chat with the first user.

In this embodiment, the creator of the three-dimensional scene may also be transmitted to the three-dimensional scene where the first user is located. That is, the method may specifically include: in response to the predefined operation of the second user for the added information, assigning the second user to the three-dimensional scene and displaying the three-dimensional scene. The process may be related to closing the relevant content currently displayed by the second user, or opening the relevant application, or loading the three-dimensional scene and so on.

The above predefined operations may be that the user clicks on “Go View” or “Send”, etc. Specifically, with reference to FIG. 14, the creator may create a three-dimensional scene called “Xiaoming World”. After the first user “AAA” leaves a message in the three-dimensional scene, the creator may click “Go View” and directly enter the three-dimensional scene where the first user “AAA” is located. It may be seen that this method is not limited to information transmission. If the creator is assigned to the same copy as the first user and the first user is still in the current copy, the creator may also communicate face-to-face with the first user.

Herein, the message content of the first user may also comprise picture form and a voice form. The creator may also click the “reply” operation to directly communicate with the first user remotely.

In one embodiment, when the three-dimensional scene corresponding to a plurality of copies, and a first user may make an added object in the first copy; the first copy is one of the copies of the three-dimensional scene, then the above assignment of the second user to the three-dimensional scene, may specifically comprise: assigning the second user to the first copy.

In one embodiment, when the added object corresponding to having the added content, the method may further comprise: in response to a reply of the fourth user for the added content in the second copy, adding content replied by the fourth user to a predetermined position of the added content; wherein the second copy is one of a plurality of copies; and/or in response to a reply of the fourth user for the added content in a second copy, sending the replied content to the first user; wherein the first user is in any one of copies of the three-dimensional scene, or in other scene.

The fourth user is another user in the three-dimensional scene.

Specifically, after the fourth user sees the added content of the first user in the three-dimensional scene, the fourth user may reply to the added content of the first user, and the reply content may be added to the predetermined position of the added content. The predetermined position may be set according to the needs, for example, when the added content is a message content as shown in FIG. 11, the predetermined position of the message content may be below the message content of the first user “AAA”. Herein, after the fourth user performs the reply, the reply content may also be sent to the first user to remind the first user that another user has commented on his message.

In the above process, the fourth user may be in a different copy from the first user, and the time of the reply by the fourth user may be at any time after the added content appears in the three-dimensional scene. That is, the above process allows different users to add content in their respective copies through asynchronous interaction, so that when a new user plays in his own copy, it may enable to see all the added content in the past, and interact with it, so as to allow for the continual continuation of the consumable value in the three-dimensional scene. And by the added content, it also may improve the fun and playability of the scene.

In one embodiment, when the added object corresponding to having the added content, the method may further comprise: in response to a reply of the added content by the fourth user in the three-dimensional scene, adding the reply content of the fourth user to the predetermined position of the added content; and/or sending the reply content to the first user.

The specific implementation of the process, due to it is described in the above embodiments, it is not described herein.

Alternatively, the form of the above reply content includes at least one of the following: a like, a click, a text, a video, an emoji, a voice, and a recorded message.

In one embodiment, when the fourth user comments on the first message of the first user, the creator of the three-dimensional scene may also receive the reply, such as shown in FIG. 14. After the user “BBB” leaves a message “XXXXXXXXX”, and after the fourth user “AAA” gives the message “XXXXXXXXX” of the user “BBB” a like, the creator may also receive the message, and at this time, the creator may also choose from the “Go View” or “Reply” operation.

Alternatively, the method may further comprise: in response to a predefined operation of a first user for the reply content, assigning the first user to the second copy, and displaying a corresponding three-dimensional scene of the second copy.

Among them, the second copy is any one of a plurality of copies corresponding to the three-dimensional scene. That is, the second copy may also be the same copy as the first copy, or the second copy may be any other copy among the plurality of copies corresponding to the three-dimensional scene. When the second copy is the same copy as the first copy, the first user is assigned to the same copy as the fourth user.

That is, the first user may actively trigger the transmission to the three-dimensional scene where the fourth user is located. The above predefined operation may be that the user clicks “Go View”, or clicking “Transmit”, etc. The specific process of transmit may be referred to in the above embodiment, which is not limited herein.

Alternatively, in one embodiment, before obtaining the added object of the first user in step 601 in response to an object addition operation of the first user in the three-dimensional scene, the method may further comprise: obtaining a selected target of the first user in response to a target determining operation of the first user in the three-dimensional scene. Correspondingly, the step 602, places the added object at a target position determined by the first user in the three-dimensional scene in response to an object placement operation of the first user in the three-dimensional scene, and may also specifically comprise: placing the added object at a target position in the selected target in response to an object placement operation of the first user in the three-dimensional scene.

Specifically, the first user may first perform the target determination operation, thereby selecting the added position, then perform the object addition operation, that is, selecting the added information. Finally, perform the object placement operation, thereby directly placing the added object in the added position selected by the first user. Herein, the object placement operation may be understood as an action in which the first user, after selecting the added object, clicks on OK to add it.

That is, the above embodiment provides a way that determining an added position first, then may determine an added object.

Alternatively, in one embodiment, step 602 in response to the object placement operation of the first user in the three-dimensional scene, placing the added object at a target position in the three-dimensional scene determined by the first user, may specifically comprise: in response to the object placement operation of the first user in the three-dimensional scene, moving the added object until it is moved to the target position in the three-dimensional scene determined by the first user.

Specifically, after the first user performs the object addition operation, the added object may be moved customizable, thereby moved to any position in the three-dimensional scene.

That is, the above embodiment provides a way that determining an added object first, then may determine an added position.

With further reference to FIG. 15, as an implementation of the methods shown in each of the above figures, the present disclosure provides one or more embodiments of a device of information interaction, which embodiment corresponds to the one or more embodiments of the method of information interaction shown in FIG. 1, and which may be specifically applied to various electronic devices.

As shown in FIG. 15, the device of information interaction of the present embodiment comprises: an obtaining unit 1501, in response to an object addition operation of the first user in a three-dimensional scene, obtaining an added object by a first user; the three-dimensional scene being created by a second user; a placement unit 1502, in response to an object placement operation of the first user in the three-dimensional scene, placing the added object at the target position determined by the first user in the three-dimensional scene.

In some embodiments, the three-dimensional scene corresponds to at least two copies; the obtaining unit 1501 is further specifically configured to in respond to the object addition operation of the first user in the three-dimensional scene, obtaining the added object by the first user; wherein, the first copy is one of a plurality of copies corresponding to the three-dimensional scene in which the first user is located. Correspondingly, the placement unit 1502 is further specifically configured to in respond to the object placement operation of the first user in the first copy, placing the added object at the target position determined by the first user in the first copy; wherein after the added object is placed at the target position in the first copy, the added object is created at the same position in a rest of the at least two copies corresponding to the three-dimensional scene.

In some embodiments, the obtaining unit 1501 is further specifically configured to in respond to in response to the object addition operation of the first user in the three-dimensional scene, obtaining the added object by the first user; after the added object placed at the target position is triggered, displaying the added content in the three-dimensional scene.

In some embodiments, the device may further comprise a trigger unit, the triggering unit in response to the position of a third user and the target position satisfying a predetermined position relation, triggering the added object to display the added content in the three-dimensional scene.

In some embodiments, the device may further comprise a trigger unit, the trigger unit in response to the triggering of the third user for the added object, triggering the added object to display the added content in the three-dimensional scene.

In some embodiments, the added content is message content, and a type of the message content comprises at least one of: a text, a picture, a video, an emoji, a voice, or recorded information.

In some embodiments, the adding object has corresponding added content; correspondingly, the device may further comprise a reply unit. The reply unit is configured to in respond to a reply of a fourth user for the added content in the three-dimensional scene, adding content replied by the fourth user to a predetermined position of the added content; and/or sending the replied content to the first user.

In some embodiments, the adding object has corresponding added content; correspondingly, the device may further comprise a reply unit. The reply unit is used to in response to a reply of the fourth user for the added content in a second copy, adding content replied by the fourth user to a predetermined position of the added content; wherein the second copy is one of a plurality of copies corresponding to the three-dimensional scene, and the second copy is different from the first copy; and/or sending the replied content to the first user.

In some embodiments, the device may further comprise an assignment unit. The assignment unit is used to in response to a predefined operation of the first user for the replied content, assigning the first user to the second copy, and displaying a three-dimensional scene corresponding to the second copy.

In some embodiments, a type of the replied content comprises at least one of: a like, a click, a text, a video, an emoji, a voice, or recorded information.

In some embodiments, the device may further comprise an assignment unit. The assignment unit is used to send added information to the second user; wherein the added information includes the added object and/or added content for the added object; in response to the predefined operation of the second user for the added information, assigning the second user to the three-dimensional scene; and displaying the three-dimensional scene.

In some embodiments, the device may further comprise a target obtaining unit. The target obtain unit is used to before in response to the object addition operation of the first user in the three-dimensional scene, obtaining the added object by the first user, in response to a target determination operation of the first user in the three-dimensional scene, obtaining a target selected by the first user. Correspondingly, the placement unit 1502, is further specifically used to in response to the object placement operation of the first user in the three-dimensional scene, placing the added object at the target position in the selected target.

In some embodiments, the placement unit 1502, is further specifically used to in response to the object placement operation of the first user in the three-dimensional scene, moving the added object until the added object is moved to the target position determined by the first user in the three-dimensional scene.

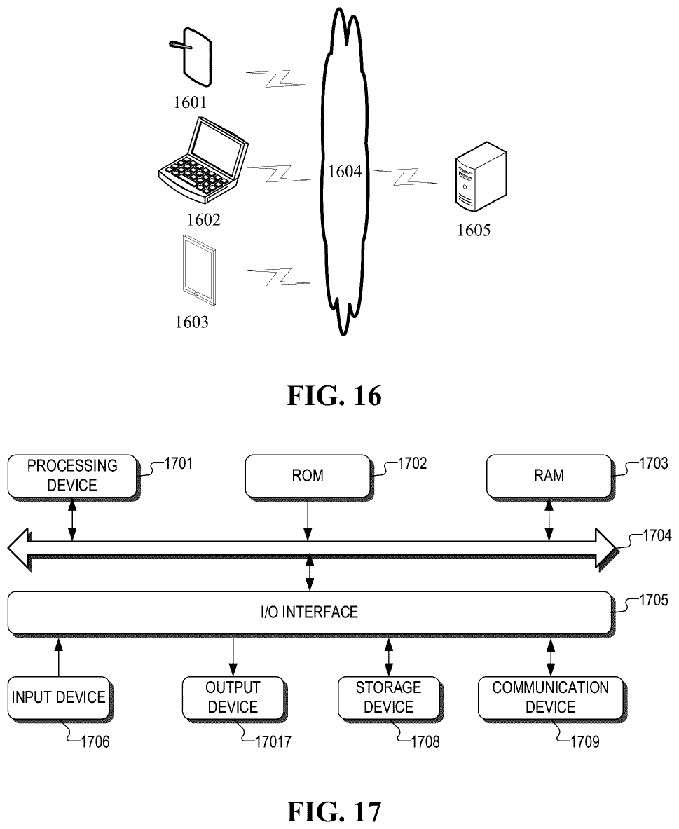

Please refer to FIG. 16, FIG. 16 shows an exemplary system architecture in which a method for interaction of one or more embodiments of the present disclosure may be applied.

As shown in FIG. 16, the system architecture may comprise terminal devices 1601, 1602, 1603, a network 1604, and a server 1605. The network 1604 may be a medium for providing a communication link between the terminal devices 1601, 1602, 1603 and the server 1605. The network 1604 may comprise various connection types, such as wired, wireless communication links or fiber optic cables, etc.

The terminal devices 1601, 1602, 1603 may interact with the server 1605 through the network 1604 to receive or send messages and the like. The terminal devices 1601, 1602, 1603 may have various client applications installed on them, such as a web browser application, a search application, and a news and information application. The client applications in the terminal devices 1601, 1602, 1603 may receive instructions from the user and complete corresponding functions according to the instructions of the user.

The terminal devices 1601, 1602, 1603 may be hardware or software. When the terminal device 1601, 1602, 1603 is hardware, it may be various electronic devices having a display and supporting web browsing, comprising, but not limited to, a VR device (e.g., a VR helmet, VR glasses), a smartphone, a tablet computer, an e-book reader, an MP3 player (Moving Picture Experts Group Audio Layer III, Moving Picture Experts Group Compression Standard Audio Layer 3), MP4 (Moving Picture Experts Group Audio Layer IV, Moving Picture Experts Group Compression Standard Audio Layer 4) players, a laptop and a desktop computer, and the like. When the terminal devices 1601, 1602, 1603 are software, they can be installed in the electronic devices listed above. It may be implemented as a plurality of software or software modules (e.g., software or software modules used to provide distributed services), or it may be implemented as a single software or software module. No specific limitations are made herein.

The server 1605 may be a server providing various services, such as receiving an information obtaining request sent by the terminal devices 1601, 1602, 1603, obtaining display information corresponding to the information obtaining request by various means based on the information obtaining request. And the relevant data of the display information is sent to the terminal devices 1601, 1602, 1603.

It is to be noted that the method for interaction provided by the embodiments of the present disclosure may be executed by a terminal device, and accordingly, the apparatus for interaction may be set in the terminal devices 1601, 1602, 1603. In addition, the method for interaction provided in the embodiments of the present disclosure may also be executed by a server 1605, and accordingly, the apparatus for interaction may be set in the server 1605.

It should be understood that the number of the terminal devices, networks, and servers in FIG. 16 is merely illustrative. There may be any number of terminal devices, networks, and servers as needed for implementation.

Referring to FIG. 17 below, it shows a schematic diagram of a basic structure of an electronic device (e.g., the terminal device or server of FIG. 16) suitable for implementing embodiments of the present disclosure. The terminal devices in the embodiments of the present disclosure may comprise, but are not limited to, mobile terminals such as a VR device (e.g., a VR headset, VR glasses), a mobile phone, a laptop computer, a digital broadcast receiver, a PDA (personal digital assistant), a PAD (tablet computer), a PMP (portable multimedia player), an in-vehicle terminal (e.g., an in-vehicle navigation terminal) and the like, and fixed terminals such as a digital TV, a desktop computer etc. The electronic device illustrated in FIG. 17 is merely an example and should not impose any limitation on the functions and scope of use of the embodiments of the present disclosure.

As shown in FIG. 17, the electronic device may comprise a processing device (e.g., a central processor, a graphics processor, etc.) 1701 that may perform various appropriate actions and processes based on programs stored in read-only memory (ROM) 1702 or loaded from the storage device 1708 into random access memory (RAM) 1703. Various programs and data necessary for the operation of the electronic device 1700 are also stored in the RAM 1703. The processing device 1701, the ROM 1702, and the RAM 1703 are connected to each other via a bus 1704. The input/output (I/O) interface 1705 is also connected to the bus 1704.

Typically, the following apparatuses may be connected to the I/O interface 1705: an input device 1706 comprising, for example, a touch screen, a touch pad, a keyboard, a mouse, a camera, a microphone, an accelerometer, a gyroscope, and the like; an output device 17017 comprising, for example, a liquid crystal display (LCD), a loudspeaker, a vibrator, and the like; a storage device 1708 comprising, for example, a magnetic tape, a hard disk, and the like; and a communication device 1709. The communication device 1709 may allow the electronic device to communicate wirelessly or wiredly with other devices to exchange data. Although FIG. 17 illustrates an electronic device with various devices, it should be understood that it is not required to implement or have all of the illustrated devices. More or fewer devices may alternatively be implemented or possessed.

In particular, according to embodiments of the present disclosure, the process described above with reference to the flowchart may be implemented as a computer software program. For example, embodiments of the present disclosure comprise a computer program product comprising a computer program carried on a non-transitory computer-readable medium, the computer program comprising program code for performing the method shown in the flowchart. In such embodiments, the computer program may be downloaded and installed from a network via a communication device 1709, or from a storage device 1708, or from a ROM 1702. When the computer program is executed by the processing device 1701, the above-described functions defined in the method of the embodiments of the present disclosure are performed.

It is noted that the computer-readable medium described above in the present disclosure may be a computer-readable signal medium or a computer-readable storage medium or any combination thereof. The computer-readable storage medium may, for example, be—but is not limited to—a system, apparatus, or device of electricity, magnetism, light, electromagnetism, infrared, or semiconductors, or any combination of the above. More specific examples of computer-readable storage media may comprise, but are not limited to: an electrical connection having one or more wires, a portable computer disk, a hard disk, a random access memory (RAM), a read-only memory (ROM), an erasable programmable read-only memory (EPROM or flash memory), a fiber optic, a compact disk read-only memory (CD-ROM) for portable computers, an optical storage device, magnetic memory device, or any suitable combination of the foregoing. In the context of the present disclosure, a computer-readable storage medium may be any tangible medium that includes or stores a program that may be used by or in combination with an instruction execution system, apparatus, or device. And in the present disclosure, a computer-readable signal medium may comprise a data signal propagated in a baseband or as part of a carrier carrying computer-readable program code. Such propagated data signals may take a variety of forms comprising, but not limited to, electromagnetic signals, optical signals, or any suitable combination of the foregoing. The computer-readable signal medium may also be any computer-readable medium other than a computer-readable storage medium that sends, propagates, or transmits a program for use by, or in combination with, an instruction-executing system, apparatus, or device. The program code included on the computer-readable medium may be transmitted using any suitable medium, comprising, but not limited to: wire, fiber optic cable, RF (radio frequency), etc., or any suitable combination of the foregoing.

In some implementations, the client, server may communicate with any currently known or future developed network protocol such as HTTP (HyperText Transfer Protocol) and may be interconnected with any form or medium of digital data communication (e.g., a communication network). Examples of communication networks comprise local area networks (“LANs”), wide area networks (“WANs”), inter-networks (e.g., the Internet), and end-to-end networks (e.g., ad hoc end-to-end networks), as well as any currently known or future-developed networks.

The above-described computer-readable medium may be included in the above-described electronic device; it may also be separate and not assembled into the electronic device.

The above-described computer-readable medium carries one or more programs, which, when executed by the electronic device, cause the electronic device to: respond to a in response to an object operation of a first user for a three-dimensional scene, send prompt information to a second user, wherein the object operation is used to modify an object in the three-dimensional scene or add an object into the three-dimensional scene, and the prompt information is used to notify an operation content of the object operation and/or the three-dimensional scene.

Computer program code for performing the operations of the present disclosure may be written in one or more programming languages or combinations thereof. The aforementioned programming languages comprise, but are not limited to, object-oriented programming languages-such as Java, Smalltalk, C++, and also comprise conventional procedural programming languages-such as the “C” language or the like. The program code may be executed entirely or partially on the user computer, as a stand-alone software package, partially on the computer of the user and partially on a remote computer, or entirely on a remote computer or server. In situations involving a remote computer, the remote computer may be connected to the user computer through any kind of network—comprising a local area network (LAN) or a wide area network (WAN)—or, alternatively, may be connected to an external computer (e.g., with the use of an Internet Service Provider to connect through the Internet).

The flowcharts and block diagrams in the accompanying drawings illustrate the architecture, functionality, and operation of systems, methods, and computer program products that may be implemented in accordance with various embodiments of the present disclosure. At this point, each block in the flowcharts or block diagrams may represent a module, program segment, or portion of code that includes one or more executable instructions for implementing a specified logical function. It should also be noted that in some implementations as replacements, the functions labeled in the blocks may also occur in a different order than those labeled in the accompanying drawings. For example, two consecutively represented blocks may actually be executed substantially in parallel, and they may sometimes be executed in reverse order, depending on the function involved. It is also noted that each of the blocks in the block diagrams and/or flowcharts, and combinations of the blocks in the block diagrams and/or flowcharts, may be implemented with a specialized hardware-based system that performs the specified function or operation, or may be implemented with a combination of specialized hardware and computer instructions.

The unit described in the embodiments of the present disclosure may be implemented by way of software or may be implemented by way of hardware. The name of the unit does not limit the unit itself in some cases. For example, the notifying unit 501 may also be described as “a unit that, in response to an object operation of the first user for the three-dimensional scene, sends the prompt information to the second user”.

The functions described above herein may be performed, at least in part, by one or more hardware logic components. For example, non-limitingly, exemplary types of hardware logic components that may be used comprise: field programmable gate arrays (FPGAs), application-specific integrated circuits (ASICs), application-specific standard products (ASSPs), systems-on-chip (SOCs), complex programmable logic devices (CPLDs), and the like.

In the context of the present disclosure, a machine-readable medium may be a tangible medium that may include or store a program for use by or in conjunction with an instruction execution system, apparatus, or device. The machine-readable medium may be a machine-readable signal medium or a machine-readable storage medium. The machine-readable medium may comprise, but is not limited to, an electronic, magnetic, optical, electromagnetic, infrared, or semiconductor system, apparatus, or device, or any suitable combination of the foregoing. More specific examples of machine-readable storage media would comprise an electrical connection based on one or more wires, a portable computer disk, a hard disk, a random-access memory (RAM), a read-only memory (ROM), an erasable programmable read-only memory (EPROM or flash memory), a fiber-optic, a convenient compact disk read-only memory (CD-ROM), an optical storage device, a magnetic storage device, or any suitable combination of the foregoing. any suitable combination of the above.

The above description is only a preferred embodiment of the present disclosure and an illustration of the technical principles utilized. It should be understood by those skilled in the art that the scope of disclosure involved in the present disclosure is not limited to technical solutions formed by a particular combination of the above technical features, but also covers other technical solutions formed by any combination of the above technical features or their equivalent features without departing from the above disclosed concept. For example, a technical solution formed by interchanging the above features with (but not limited to) technical features with similar functions disclosed in the present disclosure.

Furthermore, while the operations are depicted using a particular order, this should not be construed as requiring that the operations be performed in the particular order shown or in sequential order of execution. Multitasking and parallel processing may be advantageous in certain environments. Similarly, while several specific implementation details are included in the above discussion, these should not be construed as limiting the scope of the present disclosure. Certain features described in the context of separate embodiments may also be implemented in combination in a single embodiment. Conversely, various features described in the context of a single embodiment may also be implemented in multiple embodiments, either individually or in any suitable sub-combination.

Although the present subject matter has been described using language specific to structural features and/or method logic actions, it should be understood that the subject matter limited in the appended claims is not necessarily limited to the particular features or actions described above. Rather, the particular features and actions described above are merely exemplary forms of implementing the claims.

1. A method for interaction, comprising:
in response to an object operation of a first user for a three-dimensional scene, sending prompt information to a second user, wherein the object operation is used to modify an object in the three-dimensional scene or add an object into the three-dimensional scene, and the prompt information is used to notify an operation content of the object operation and/or the three-dimensional scene.

2. The method of claim 1, wherein the method further comprises:
in response to a predetermined operation of the second user for the prompt information, transferring the second user to the three-dimensional scene and displaying the three-dimensional scene.

3. The method of claim 1, wherein the three-dimensional scene corresponds to at least two copies, the method further comprises:
after the first user performs the object operation in a current copy, performing a same operation as the object operation in at least one further copy corresponding to the three-dimensional scene.

4. The method of claim 2, wherein the three-dimensional scene corresponds to at least two copies, and the in response to an object operation of a first user for a three-dimensional scene, sending prompt information to a second user comprises:
in response to an object operation of the first user in a first copy, sending the prompt information to the second user, wherein the first copy is one of the at least two copies of the three-dimensional scene; and
wherein in response to a predetermined operation of the second user for the prompt information, transferring the second user to the three-dimensional scene comprises:
in response to a predetermined operation of the second user for the prompt information, and in response to determining that the first user is located in the first copy, transferring the second user to the first copy.

5. The method of claim 4, wherein the prompt information is displayed in a second copy where the second user is located, and the second copy is one of at least two copies of the three-dimensional scene, the second copy being different from the first copy;
wherein the transferring the second user to the first copy comprises:
transferring the second user from the second copy to the first copy.

6. The method of claim 4, wherein the prompt information is displayed in another scene where the second user is located;
wherein the transferring the second user to the first copy comprises:
transferring the second user from the other scene to the first copy.

7. The method of claim 2, wherein the transferring the second user to the three-dimensional scene comprises:
transferring the second user to a target location in the three-dimensional scene;
wherein the target location comprises any of: an initial position of a user in the three-dimensional scene, a position corresponding to the object operation, and a position corresponding to the first user.

8. The method of claim 7, wherein the transferring the second user to a target location in the three-dimensional scene comprises:
transferring the second user to the target location in the three-dimensional scene, and turning the second user towards an object corresponding to the object operation; or
transferring the second user to the target location in the three-dimensional scene, and in response to determining that the first user is located in the three-dimensional scene, turning the second user towards the first user.

9. The method of claim 1, wherein the method further comprises:
in response to a reply operation of the second user for the prompt information, adding a reply content to the three-dimensional scene, or
in response to the reply operation of the second user for the prompt information, sending the reply content to the first user.

10. The method of claim 1, wherein the second user is a user associated with an object corresponding to an object operation of the first user, or the second user is a user associated with the three-dimensional scene.

11. The method of claim 1, comprising:
in response to an object addition operation of the first user in the three-dimensional scene, obtaining an added object by the first user; the three-dimensional scene being created by the second user; and
in response to an object placement operation of the first user in the three-dimensional scene, placing the added object at a target position determined by the first user in the three-dimensional scene.

12. The method of claim 11, wherein
the three-dimensional scene corresponds to at least two copies; and
in response to the object addition operation of the first user in the three-dimensional scene, obtaining the added object by the first user comprises:
in response to the object addition operation of the first user in a first copy of the at least two copies, obtaining the added object by the first user, wherein the first copy is one of a plurality of copies corresponding to the three-dimensional scene in which the first user is located; and
in response to the object placement operation of the first user in the three-dimensional scene, placing the added object at the target position determined by the first user in the three-dimensional scene comprises:
in response to the object placement operation of the first user in the first copy, placing the added object at the target position determined by the first user in the first copy; wherein after the added object is placed at the target position in the first copy, the added object is created at the same position in a rest of the at least two copies corresponding to the three-dimensional scene.

13. The method of claim 11, wherein
in response to the object addition operation of the first user in the three-dimensional scene, obtaining the added object by the first user comprises:
in response to the object addition operation of the first user in the three-dimensional scene, obtaining the added object by the first user and added content for the added object; and
the method further comprises:
after the added object placed at the target position is triggered, displaying the added content in the three-dimensional scene.

14. The method of claim 13, further comprising:
in response to the position of a third user and the target position satisfying a predetermined position relation, triggering the added object to display the added content in the three-dimensional scene; or
in response to the triggering of the third user for the added object, triggering the added object to display the added content in the three-dimensional scene.

15. The method of claim 11, wherein
the added object has corresponding added content; and
the method further comprises:
in response to a reply of a fourth user for the added content in the three-dimensional scene, adding content replied by the fourth user to a predetermined position of the added content; and/or
sending the replied content to the first user.

16. The method of claim 12, wherein
the added object has corresponding added content; and
the method further comprises:
in response to a reply of the fourth user for the added content in a second copy, adding content replied by the fourth user to a predetermined position of the added content; wherein the second copy is one of a plurality of copies corresponding to the three-dimensional scene, and the second copy is different from the first copy; and/or
sending the replied content to the first user.

17. The method of claim 11, further comprising:
sending added information to the second user; wherein the added information includes the added object and/or added content for the added object;
in response to the predefined operation of the second user for the added information, assigning the second user to the three-dimensional scene; and
displaying the three-dimensional scene.

18. The method of claim 11, wherein
before in response to the object addition operation of the first user in the three-dimensional scene, obtaining the added object by the first user, the method further comprises:
in response to a target determination operation of the first user in the three-dimensional scene, obtaining a target selected by the first user; and
in response to the object placement operation of the first user in the three-dimensional scene, placing the added object at the target position determined by the first user in the three-dimensional scene comprises:
in response to the object placement operation of the first user in the three-dimensional scene, placing the added object at the target position in the selected target.

19. An electronic device, comprising:
one or more processors; and
a storage device for storing one or more programs,
wherein the one or more programs, when executed by the one or more processors, cause the one or more processors to implement acts comprising:
in response to an object operation of a first user for a three-dimensional scene, sending prompt information to a second user, wherein the object operation is used to modify an object in the three-dimensional scene or add an object into the three-dimensional scene, and the prompt information is used to notify an operation content of the object operation and/or the three-dimensional scene.

20. A non-transitory computer-readable medium having a computer program stored thereon, the program, when executed by a processor, implementing a method comprising:
in response to an object operation of a first user for a three-dimensional scene, sending prompt information to a second user, wherein the object operation is used to modify an object in the three-dimensional scene or add an object into the three-dimensional scene, and the prompt information is used to notify an operation content of the object operation and/or the three-dimensional scene.
